(19) United States
(12) Patent Application Publication
(10) Pub. No.: US 2022/0363196 A1
(43) Pub. Date: Nov. 17, 2022

(54) VEHICLE DISPLAY SYSTEM WITH WEARABLE DISPLAY

(71) Applicant: Stoneridge Electronics A.B., Solna (SE)

(72) Inventor: Alfred van den Brink, Barneveld (NL)

(21) Appl. No.: 17/766,062

(22) PCT Filed: Oct. 2, 2020
(86) PCT No.: PCT/EP2020/077756

§ 371 Date: Apr. 1, 2022

Related U.S. Application Data
(60) Provisional application No. 62/909,830, filed on Oct. 3, 2019.

(51) Int. Cl. B60R 1/23; G06T 11/00; G06F 3/01; H04N 5/265

(52) U.S. Cl. CPC B60R 1/23; G06T 11/00; G06F 3/012; H04N 5/265; B60R 2300/802; B60R 2300/20; B60R 2300/304

(57) ABSTRACT

An example display system for a commercial vehicle includes a camera configured to record images of a blind spot of the commercial vehicle and a wearable augmented reality display device that includes an electronic display and is configured to be worn on the head of a driver of the commercial vehicle. An electronic control unit is configured to display graphical elements on the electronic display that depict at least one of portions of the recorded images and information derived from the recorded images. A method of displaying graphical elements is also disclosed.

### CROSS-REFERENCE TO RELATED APPLICATIONS

This application claims the benefit of U.S. Provisional Application No. 62/909,830, filed Oct. 3, 2019, the disclosure of which is incorporated by reference herein in its entirety.

### BACKGROUND

This application relates to display systems, and more particularly to a display system for a vehicle that includes a wearable augmented reality display device.

Commercial vehicles have blind spots where direct view of the vehicle exterior is obstructed, making it challenging for drivers to detect safety obstacles.

### SUMMARY

A display system for a commercial vehicle according to an example of the present disclosure includes a camera configured to record images of a blind spot of the commercial vehicle and a wearable augmented reality display device which includes an electronic display and is configured to be worn on the head of a driver of the commercial vehicle. An electronic control unit is configured to display graphical elements on the electronic display that depict at least one of portions of the recorded images and information derived from the recorded images.

In a further embodiment of any of the foregoing embodiments, a positioning sensor on the wearable augmented reality display device is configured to obtain data indicative of a viewing direction of the driver, and the electronic control unit is configured to base the displaying of the graphical elements on the viewing direction of the driver.

In a further embodiment of any of the foregoing embodiments, the electronic control unit is configured to display the graphical elements in an area of the electronic display that is in a current field of view of the driver and corresponds to the blind spot, such that the graphical elements are superimposed on the blind spot.

In a further embodiment of any of the foregoing embodiments, the electronic control unit is configured to detect an object in the images, and display a schematic representation of the object in the area.

In a further embodiment of any of the foregoing embodiments, the electronic control unit is configured to associate a windshield area used for mounting rearview mirrors in non-commercial vehicles with a blind spot behind the commercial vehicle, and determine that the blind spot behind the commercial vehicle is part of the current field of view of the driver based on the current field of view including said windshield area.

In a further embodiment of any of the foregoing embodiments, the camera is one of a plurality of cameras configured to record images of respective blind spots of the commercial vehicle, and the electronic control unit is configured to select one of the plurality of cameras based on the viewing direction, and obtain or derive the graphical elements from images provided by the selected camera.

In a further embodiment of any of the foregoing embodiments, the blind spots correspond to one or more of areas obstructed by A pillars of the commercial vehicle, areas obstructed by exterior mirrors of the commercial vehicle, and an area behind a trailer of the commercial vehicle.

In a further embodiment of any of the foregoing embodiments, at least one vehicle operation sensor is configured to obtain data indicative of how the driver is operating the commercial vehicle, and the electronic control unit is configured to display additional graphical elements on the electronic display based on the obtained data.

In a further embodiment of any of the foregoing embodiments, the obtained data indicates one or both of a shift position of a gear selection device and a steering angle of the commercial vehicle.

In a further embodiment of any of the foregoing embodiments, the additional graphical elements depict one or more of a speed of the commercial vehicle, the shift position of the commercial vehicle, and a telltale indication of the commercial vehicle.

In a further embodiment of any of the foregoing embodiments, a cabin camera is configured to record images of a cabin of the commercial vehicle, and the electronic control unit is configured to detect the blind spot based on images recorded by the cabin camera.

A method of displaying graphical elements according to an example of the present disclosure includes recording images of a blind spot of a commercial vehicle using a camera, and displaying graphical elements on an electronic display that depict at least one of portions of the recorded images and information derived from the recorded images. The electronic display is part of a wearable augmented reality display device configured to be worn on the head of a driver of the commercial vehicle.

In a further embodiment of any of the foregoing embodiments, the method includes detecting a viewing direction of the driver, and performing the displaying based on the detected viewing direction.

In a further embodiment of any of the foregoing embodiments, the displaying includes displaying the graphical elements in an area of the electronic display that is in a current field of view of the driver and corresponds to the blind spot, such that the graphical elements are superimposed on the blind spot.

In a further embodiment of any of the foregoing embodiments, the method includes detecting an object in the images, and depicting a schematic representation of said object in said area.

In a further embodiment of any of the foregoing embodiments, the method includes associating a windshield area used for mounting rearview mirrors in non-commercial vehicles with a blind spot behind the commercial vehicle, and determining that the blind spot behind the commercial vehicle is part of the current field of view of the driver based on the current field of view including the windshield area.

In a further embodiment of any of the foregoing embodiments, the camera is one of a plurality of cameras configured to record images of respective blind spots of the commercial vehicle, and the method includes selecting one of the plurality of cameras based on the viewing direction, and obtaining or deriving the graphical elements from images provided by the selected camera.

In a further embodiment of any of the foregoing embodiments, the method includes obtaining data indicative of how the driver is operating the commercial vehicle, and displaying additional graphical elements on the electronic display based on the obtained data.

In a further embodiment of any of the foregoing embodiments, the method includes obtaining data indicative of how the driver is operating the commercial vehicle includes obtaining data indicative of one or both of a shift position of a gear selection device and a steering angle of the commercial vehicle.

In a further embodiment of any of the foregoing embodiments, the method includes recording images of an interior of a cabin of the commercial vehicle, and detecting the blind spot based on the images of the interior of the cabin.

### BRIEF DESCRIPTION OF THE DRAWINGS

FIG. 1A schematically illustrates a first view of a commercial vehicle and a plurality of blind spots associated with the commercial vehicle.

FIG. 1B schematically illustrates an enlarged portion of FIG. 1A.

FIG. 2 schematically illustrates a front view of the commercial vehicle of FIG. 1, and additional blind spots associated with the commercial vehicle.

FIG. 3 schematically illustrates a side view of the commercial vehicle of FIG. 1, and an additional blind spot associated with the commercial vehicle.

FIG. 4 schematically illustrates an example display system for a commercial vehicle.

FIG. 5 schematically illustrates an example scene displayed on an electronic display of a wearable augmented reality display device.

FIG. 6 schematically illustrates a plurality of example camera locations for the display system of FIG. 4.

FIG. 7 is a flow chart depicting an example method of displaying graphical elements to a driver of a commercial vehicle.

FIG. 8A illustrates a top view of an example driver field of view.

FIG. 8B illustrates a side view of an example driver field of view.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

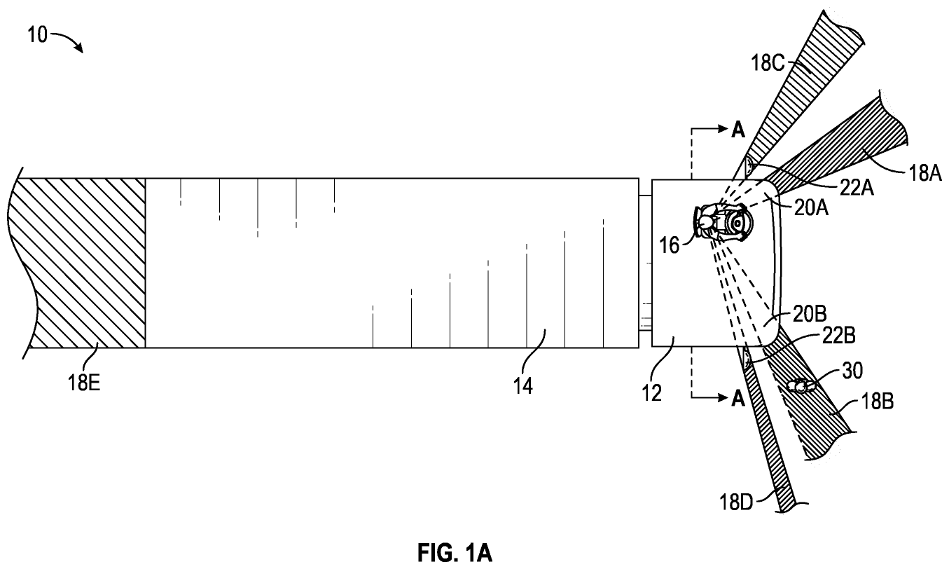

FIG. 1A schematically illustrates a first view of a commercial vehicle 10 that includes a tractor 12 and a trailer 14. A driver 16 in the tractor 12 operates the commercial vehicle 10. A plurality of blind spots 18A-E are associated with the commercial vehicle 10, including blind spots 18A-B which are obstructed by vehicle A pillars 20A-B, blind spots 18C-D which are obstructed by vehicle mirrors 22A-B, and blind spot 18E which is obstructed by the trailer 14. Due to the blind spots 18, a vulnerable road user (VRU) 30, such as a pedestrian or cyclist, which is within the blind spot 18B in FIG. 1, may not be visible to the driver 16.

FIG. 1B schematically illustrates an enlarged portion of FIG. 1A, including the blind spots 18A-D, in greater detail. As shown in FIG. 1B, vehicle pillar 20A separates window 28A from windshield 29, and pillar 20B separates window 28B from windshield 29.

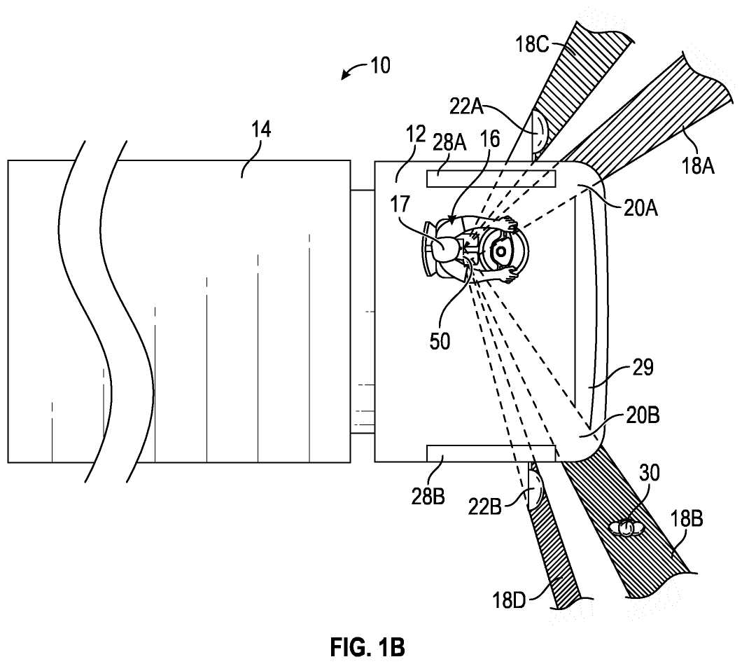

FIG. 2 schematically illustrates a front view of the commercial vehicle 10 and also illustrates a plurality of lateral blind spots 18F-G that are associated with the commercial vehicle 10 and are caused by the lateral sides 24A-B of the tractor 12.

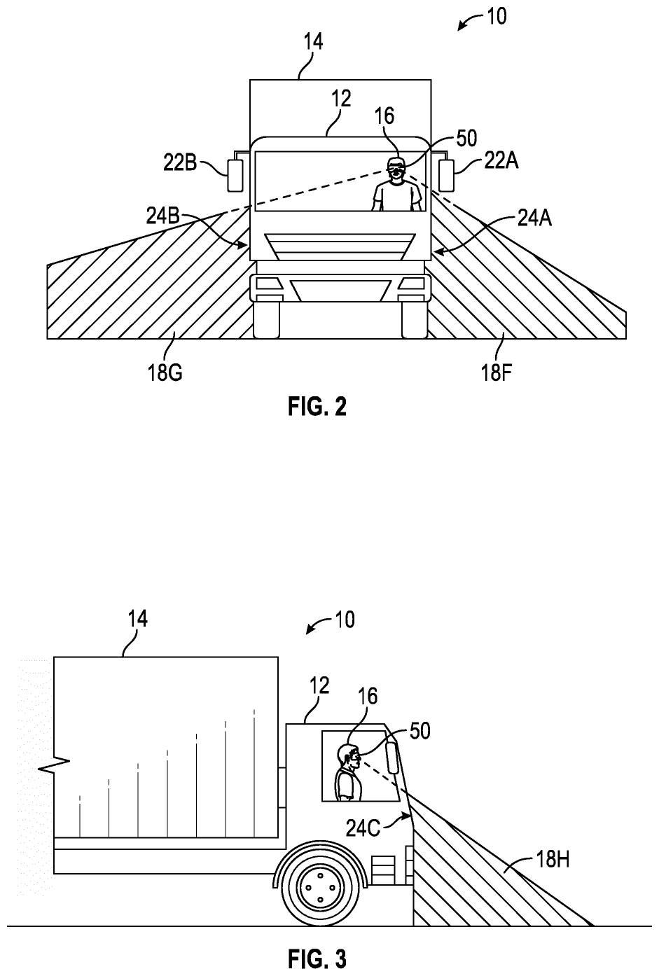

FIG. 3 schematically illustrates a side view of the commercial vehicle 10, and a blind spot 18H associated with the commercial vehicle 10 and caused by a front side 24C of the tractor 12. As shown in FIGS. 1A, 1B, 2, and 3, there are numerous blind spots 18 which present challenges for the driver 16, and make it difficult to see a variety of areas around the commercial vehicle 10.

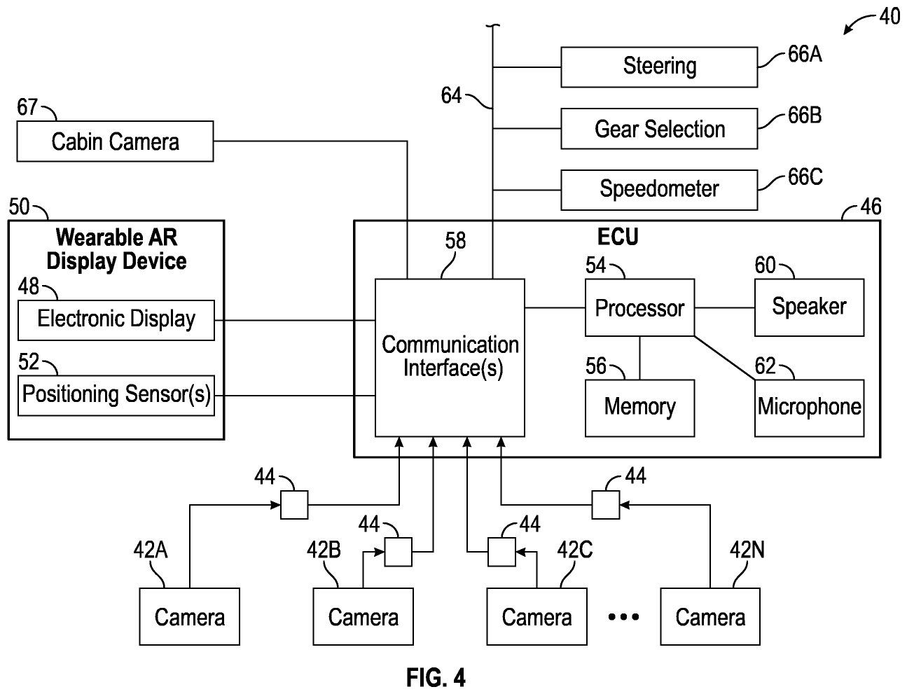

FIG. 4 schematically illustrates an example display system 40 for the commercial vehicle 10 that helps overcome these challenges by displaying images corresponding to the blind spots 18 to the driver 16. The display system 40 includes a plurality of cameras 42A-N configured to record images 44 of the blind spots 18 of the commercial vehicle 10. Some or all of the plurality of cameras 42 are video cameras in one example, whose images are streamed to the driver 16.

The cameras 42 provide the images 44 to an electronic control unit (ECU) 46 which then selectively displays graphical elements which are based on the images 44 on a see-through electronic display 48 which is part of a wearable augmented reality display device 50 configured to be worn on a head 17 of the driver 16 (e.g., as glasses, goggles, or a mask) (see FIG. 1B).

Unlike virtual reality, which refers to a simulated experience in which viewers view images using non-see through displays, augmented reality refers to an arrangement whereby a viewer can view “real world” images where some aspects of that real-world are enhanced by electronic images. Some known augmented reality (AR) systems superimpose images on a video feed of a real world environment (e.g., a room as depicted on a video feed from one's own cell phone), such that objects not present in the room appear in the display of the room depicted in the video feed.

In one example, the wearable AR display device 50 utilizes a see through display, such that the driver 16 can directly observe the environment around them even when no images are displayed (e.g., when the electronic display 48 is off), and when images are displayed those images are superimposed on the environment viewed by the driver 16.

In one example, the display device 50 is GLASS from GOOGLE, a HOLO LENS from MICROSOFT, or a pair of NREAL glasses.

The ECU 46 is operable to base the displaying of the graphical elements on a viewing direction of the driver 16. The ECU 46 is further configured to select one or more of the vehicle cameras 42 based on the viewing direction of driver 16, and to obtain or derive the graphical elements to be displayed from the images 44 provided by the one or more selected cameras 42. Thus, in some examples the display system 40 can be a multi-view system that presents multiple blind spot views to the driver 16 simultaneously (e.g., as a streaming video feed).

The images displayed on the electronic display 48 could include portions of the recorded images 44 and/or information derived from the recorded images, such as schematic depictions of detected objects, such as VRUs.

The ECU 46 includes a processor 54 that is operatively connected to memory 56 and a communication interface 58. The processor 54 includes processing circuitry for processing the images 44 from the cameras 42 and for determining whether any vehicle blind spots 18 are currently in a field of view of the driver 16. The processor 54 may include one or more microprocessors, microcontrollers, application specific integrated circuits (ASICs), or the like, for example.

The ECU also includes memory 56, which can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 56 may incorporate electronic, magnetic, optical, and/or other types of storage media. The memory 56 can also have a distributed architecture, where various components are situated remotely from one another, but can be accessed by the processor 54.

A communication interface 58 is configured to facilitate communication with the cameras 42 and the wearable AR display device 50. The communication interface 58 can facilitate wired and/or wireless communications with the cameras 42 and wearable AR display device 50. In one example, the communication interface 58 includes multiple communication interfaces, such as a wireless interface for communicating with one of the cameras 42 and wearable display device 50 and a wired communication interface for communicating with others of the cameras 42 and the wearable display device 50.

The wearable display device 50 includes one or more positioning sensors 52 that obtain data indicative of a viewing direction of the driver, which is also indicative of a field of view of the driver 16. The positioning sensors 52 could include any one or combination of accelerometers, magnetometers, or gyroscopes, for example, to determine an orientation of the driver's head 17 and a viewing direction of the driver 16. Of course, it is understood that these are only examples and that other techniques, such as gaze tracking, could be used to determine the viewing direction of the driver 16. One such technique could involve object detection of predefined known objects in the vehicle cabin that the ECU 46 could use to infer a viewing direction of the driver 16. Such objects could be detected from a camera worn by the driver 16, for example.

The ECU 46 includes a speaker 60 and microphone 62. The speaker 60 is operable to emit audible tones to the driver 16 in conjunction with displaying graphical elements on the electronic display 48. In one example the audible tones include warning sounds if an object, such as a VRU, is detected in a blind spot 18. Such warnings could include a perceived risk level of impact in some examples (e.g., higher risk if VRU is in front of the commercial vehicle 10 and the commercial vehicle 10 is approaching the VRU, and a lower risk if the VRU is on the side of the road and the commercial vehicle 10 is predicted to drive past the VRU). The microphone 62 is operable to receive spoken commands from the driver 16, such as turning the electronic display 48 on (for displaying images on the electronic display 48) or off (for precluding display of images on the electronic display 48). In one example, the driver 16 can use spoken commands to request a specific viewing area associated with one or more of the cameras 42, and the ECU 46 responds by displaying the requested area.

The ECU 46 is also in communication with a vehicle bus 64, such as a Controller Area Network (CAN) bus that is operable to provide data regarding operation of the commercial vehicle 10 from one or more vehicle operation sensors 66, such as, e.g., a steering angle sensor 66A, a gear selection sensor 66B operable to indicate a shift position (e.g., park, neutral, drive, reverse), and a speedometer sensor 66C. In one example, the ECU 46 is operable to display additional graphical elements on the electronic display based on the vehicle operation data (e.g., overlaying a vehicle speed on the electronic display 48) and/or is operable to determine how it depicts data derived from the images 44 based on data from the vehicle operation sensors 66 (e.g., determining driver field of view based on steering angle and/or triggering display of rear vehicle camera images based on the commercial vehicle 10 being in reverse). In one example, the ECU 46 is operable to overlay a graphical element on the electronic display 48 that corresponds to a vehicle “telltale” indication, such as a “check engine” light, an engine overheating condition, a low tire pressure condition, etc.

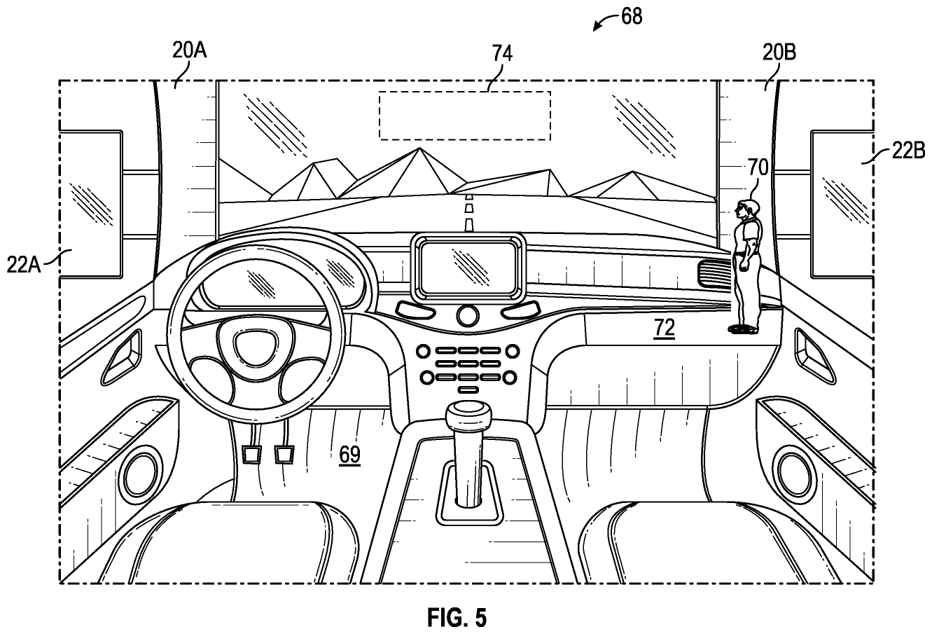

In one example the display system 40 includes a cabin camera 67 configured to record images of the cabin 69 of the commercial vehicle 10 (see FIG. 5), and the ECU 46 is configured to detect a location of at least one of the blind spots 18 based on images recorded by the cabin camera 67. For example, the ECU 46 could determine which portions of the vehicle cabin are generally static during vehicle movement, and could infer that those locations correspond to vehicle blind spots 18, as they do not correspond to vehicle windows 28A-B, 29. Thus, in one example the ECU 46 is able to recognize the vehicle cabin 69 and calibrate itself based on images from the cabin camera 67.

In one example, the electronic display 48 can be used to supplement or replace an instrument cluster of the commercial vehicle 10, by displaying information typically associated with an instrument cluster (e.g., speed, shift position, fuel level, fuel mileage, odometer, telltale warnings, etc.) in an area of the vehicle cabin 69 typically associated with an instrument cluster (e.g., behind steering wheel and beneath driver's side dashboard). Of course, other display areas could be used instead.

In one example, the ECU 46 communicates with navigation device (e.g., a Global Navigation Satellite System “GNSS” device, such as the Global Positioning System “GPS” device) to determine navigation instructions for a driver, and displays information based on such instructions on the electronic display 48, such as upcoming turns, distance markers indicating distances to such turns, etc.

In one example, the ECU 46 utilizes the electronic display 48 to highlight important road signs to the driver 16, such as traffic signs, road markers, etc. that are of particular interest to the driver 16. This could be performed in conjunction with the navigation features described above, for example. The ECU 46 could also display a vehicle trajectory on the electronic display 48 (e.g., for when the commercial vehicle 10 is making turns or driving in reverse).

FIG. 5 schematically illustrates an example scene 68 of a cabin 69 of the commercial vehicle 10 as viewed through the electronic display 48 of the wearable AR display device 50 when the driver 16 is looking forward. A graphical element 70 corresponding to the VRU 30 is depicted in the scene 68 in an area of the electronic display 48 that is in the current field of view of the driver 16 and corresponds to the blind spot 18B in FIGS. 1A-B. The graphical element 70 is superimposed on the blind spot 18B in which the VRU 30 is disposed. This provides an effect whereby the driver 16 is able to “see through” portions of the vehicle to view an area outside of the commercial vehicle 10. Thus, the driver 16 is able to see through the vehicle A pillar 20B and a portion 72 of the vehicle cabin 69 which also obstructs the driver's view of the VRU 30. The rest of the scene 68 is viewable because the driver 16 can see through the electronics display 48. Thus, in one operating mode the electronic display 48 displays nothing and simply permits the driver 16 to use their natural viewing capability, and in a second mode overlays graphical elements onto the electronic display 48 so that hidden objects can be seen.

In one example, the ECU 46 is configured to detect objects (e.g., VRUs 30) in the blind spots 18, and to display those objects or schematic representations of the objects on the electronic display 48. Although only the VRU is shown in the graphical element 70 of FIG. 5, it is understood that other elements could be displayed as well, such as a region around the VRU (e.g., a rectangular region cropped from an image of the blind spot 18B.

The scene 68 of FIG. 5 includes an area 74 that is used for mounting rearview mirrors in non-commercial vehicles. In one example, the ECU 46 is operable to associate the area 74 with the blind spot 18E behind the trailer 14 of the commercial vehicle 10 (see FIG. 1), and to determine that the blind spot 18E behind the commercial vehicle is part of the current field of view of the driver 16 based on the current field of view of the driver 16 including the area 74. The ECU 46 is further configured to display graphical elements corresponding to the blind spot 18E in the area 74 based on the determination that the area 74 is in the driver's field of view.

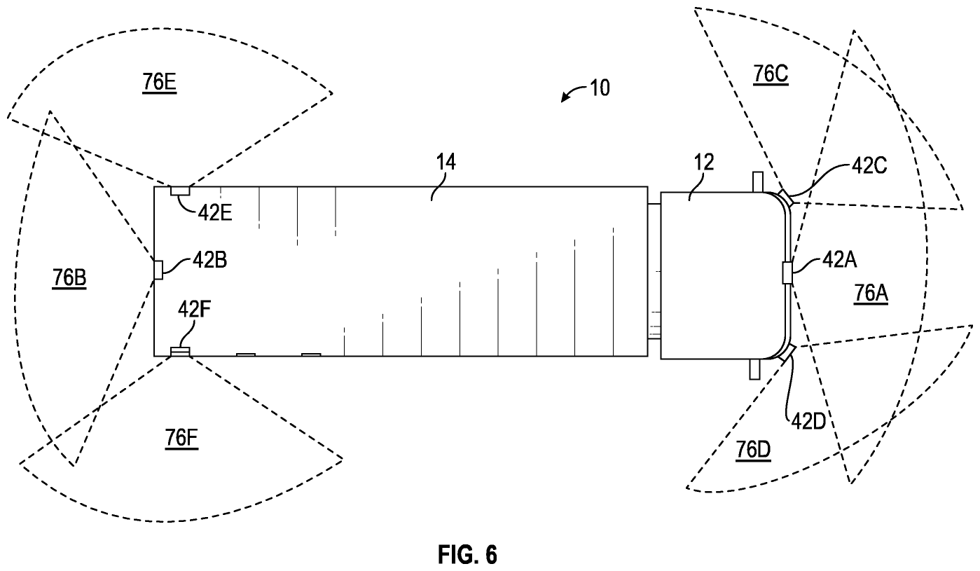

FIG. 6 schematically illustrates a plurality of example camera locations for the cameras 42A-N of FIG. 4, which are each configured to record images of blind spots of the commercial vehicle 10. As shown in FIG. 6, camera 42A provides a view 76A in front of the tractor 12, camera 42B provides a view 76B behind the trailer 14, cameras 42C and 42D provide respective front corner views 76C and 76D, and cameras 42E and 42F provide respective rear corner views 76E and 76F. Of course, these are only example locations, and it is understood that other camera locations and other quantities of cameras could be used.

The ECU 46 is configured to select one or more of the plurality of cameras based on the viewing direction of the driver 16, and obtain or derive the graphical elements from images provided by the selected camera 42. For example, if the driver 16 is looking out the driver side window 28A and blind spots 18B and 18D are not within the field of view of the driver 16, the ECU 46 in one example, does not display images obtained or derived from the cameras corresponding to blind spots 18B and 18D on the electronic display 48. By selecting which cameras 42 to utilize based on the driver's viewing direction, the ECU 46 is able to present the graphical elements that are most relevant to the driver 16 at the time that the driver 16 is utilizing that viewing direction.

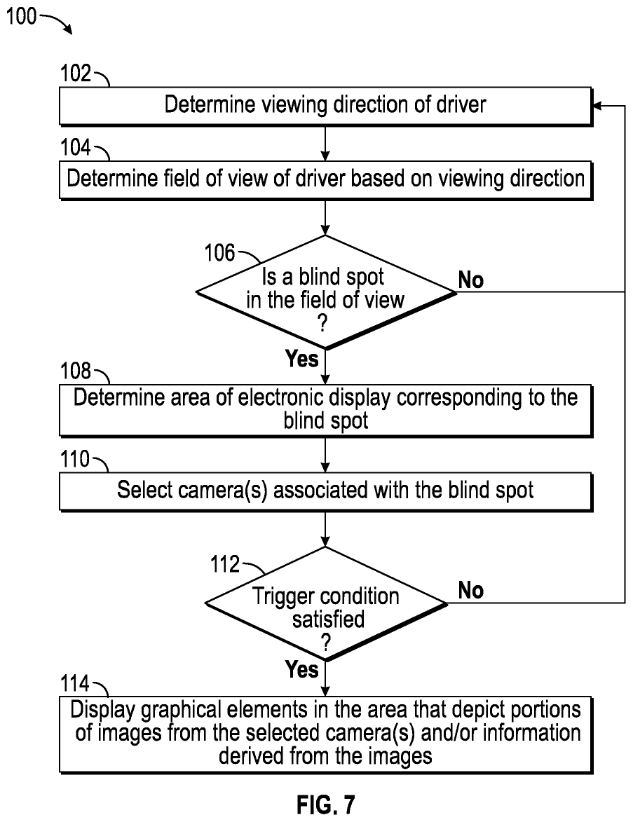

FIG. 7 is a flow-chart depicting an example method 100 of displaying graphical elements to the driver 16 of the commercial vehicle 10. The ECU 46 determines a viewing direction of the driver 16 (step 102), and determines a field of view of the driver 16 based on the viewing direction (step 104). The ECU 46 determines if a blind spot 18 is in the field of view (step 106). If no blind spot 18 of the commercial vehicle 10 is in the field of view (a “no” to step 106), the ECU 46 continues monitoring the viewing direction of the driver 16.

If a blind spot 18 of the commercial vehicle 10 is in the field of view of the driver 16 (a “yes” to step 106), the ECU 46 determines an area of the electronic display 48 corresponding to the blind spot (step 108). The ECU 46 selects one or more of the cameras 42 associated with the blind spot 18 (step 110). The ECU 46 determines whether a trigger condition is satisfied (step 112). If the trigger condition is not satisfied (a “no” to step 112), the ECU 46 continues monitoring the viewing direction of the driver 16. If the trigger condition is satisfied (a “yes” to step 112), the ECU 46 displays graphical elements in the determined area from step 108 that depict portions of the images 44 from the selected camera(s) 42 and/or depicts information derived from the images 44 from the selected camera(s) 42 (step 114). In one example, step 114 includes displaying a schematic representation of a detected object, such as a VRU, on the electronic display 48 (see, e.g., graphical element 70 in FIG. 5).

The ECU 46 can use a variety of different trigger conditions for step 112. In one example, the trigger condition includes detection of a VRU within one of the blind spots 18. In one example, the trigger condition includes the driver 16 having activated the electronic display 48. In one example, the trigger condition comprises detection of another motor vehicle in one of the blind spots 18. In one example, the trigger condition includes the driver 16 putting the commercial vehicle 10 in reverse. In one example, the trigger condition includes a level of daylight being below a predefined threshold. In one example, the trigger condition includes detection of a vehicle that is intending to pass the commercial vehicle 10 on a road. Of course, these are non-limiting examples and other trigger conditions could be used.

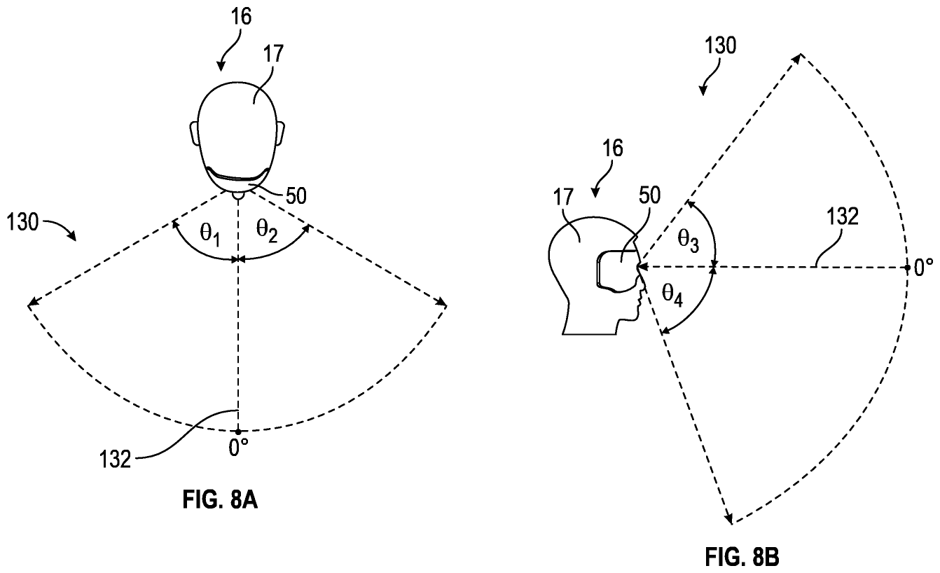

FIG. 8A illustrates a top view of an example driver field of view 130. In the example of FIG. 8A, the field of view 130 spans approximately 124° horizontally, with angles Θ₁ and Θ₂ from centerline 132 each being approximately 62°.

FIG. 8B illustrates a side view of the example driver field of view 130. In the example of FIG. 8B, the field of view 130 spans approximately 120° vertically, with angle Θ₃ being approximately 50° and angle Θ₄ being approximately 70°.

In one example, the ECU 46 is operable to determine the field of view 130 based on the viewing direction of the driver 16, as the viewing angles discussed above can be determined from the direction. In one example, the ECU 46 is further operable to determine the field of view 130 based on an angle of the driver's head 17 (e.g., whether tilted upwards from centerline 132, tilted downwards from centerline 132, or non-tilted with respect to the centerline 132).

The display system 40 described herein can facilitate the use of numerous vehicle cameras 42 without including a respective dedicated electronic display in the cabin 69 for each camera 42 of the commercial vehicle 10, thereby reducing clutter in the cabin 69, and simplifying design of the cabin 69. Also, reducing the number of electronic displays that may otherwise be needed to use a plurality of external cameras 42 could reduce driver distraction. In embodiments where the electronic display 48 is a see-through display, the display 48 does not obstruct the view of the driver 16 when nothing is being displayed by the ECU 46.

As discussed in the examples above, the display system 40 is operable to provide camera images from a viewing perspective of the driver 16 or from other perspectives, such as that of rear vehicle camera 42B. In some examples, the display system 40 is operable to provide other views, such as a birds eye view (e.g., from camera 42A or as a composite image from various ones of the cameras 42), or a view from some other point in 3D space away from the driver and/or outside of the vehicle cabin (e.g., from cameras 42E-F).

Although example embodiments have been disclosed, a worker of ordinary skill in this art would recognize that certain modifications would come within the scope of this disclosure. For that reason, the following claims should be studied to determine the scope and content of this disclosure.

1. A display system for a commercial vehicle, comprising:
a camera configured to record images of a blind spot of the commercial vehicle;
a wearable augmented reality display device configured to be worn on the head of a driver of the commercial vehicle and comprising an electronic display;
a positioning sensor on the wearable augmented reality display device that is configured to obtain data indicative of a viewing direction of the driver; and
an electronic control unit configured to display graphical elements on the electronic display that depict at least one of portions of the recorded images and information derived from the recorded images, wherein the electronic control unit is configured to base the displaying of the graphical elements on the viewing direction of the driver;
wherein the camera is one of a plurality of cameras configured to record images of respective blind spots of the commercial vehicles; and
wherein the electronic control unit is configured to:
select one of the plurality of cameras based on the viewing direction; and
obtain or derive the graphical elements from images provided by the selected camera.

2. (canceled)

3. The display system of claim 1, wherein the electronic control unit is configured to display the graphical elements in an area of the electronic display that is in a current field of view of the driver and corresponds to the blind spot, such that the graphical elements are superimposed on the blind spot.

4. The display system of claim 3, wherein the electronic control unit is configured to detect an object in the images, and display a schematic representation of the object in the area.

5. The display system of claim 3, wherein the electronic control unit is configured to:
associate a windshield area used for mounting rearview mirrors in non-commercial vehicles with a blind spot behind the commercial vehicle; and
determine that the blind spot behind the commercial vehicle is part of the current field of view of the driver based on the current field of view including said windshield area.

6. (canceled)

7. The display system of claim 1, wherein the blind spots correspond to one or more of:
areas obstructed by A pillars of the commercial vehicle;
areas obstructed by exterior mirrors of the commercial vehicle; and
an area behind a trailer of the commercial vehicle.

8. The display system of claim 1, comprising:
at least one vehicle operation sensor configured to obtain data indicative of how the driver is operating the commercial vehicle;
wherein the electronic control unit is configured to display additional graphical elements on the electronic display based on the obtained data.

9. The display system of claim 8, wherein the obtained data indicates one or both of a shift position of a gear selection device and a steering angle of the commercial vehicle.

10. The display system of claim 8, wherein the additional graphical elements depict one or more of a speed of the commercial vehicle, the shift position of the commercial vehicle, and a telltale indication of the commercial vehicle.

11. The display system of claim 1, comprising:
a cabin camera configured to record images of a cabin of the commercial vehicle, wherein the electronic control unit is configured to detect the blind spot based on images recorded by the cabin camera.

12. A method of displaying graphical elements, comprising:
recording images of a blind spot of a commercial vehicle using a camera; and
displaying graphical elements on an electronic display that depict at least one of portions of the recorded images and information derived from the recorded images, the electronic display being part of a wearable augmented reality display device configured to be worn on the head of a driver of the commercial vehicle.

13. The method of claim 12, comprising:
detecting a viewing direction of the driver; and
performing said displaying based on the detected viewing direction.

14. The method of claim 13, wherein said displaying comprises displaying the graphical elements in an area of the electronic display that is in a current field of view of the driver and corresponds to the blind spot, such that the graphical elements are superimposed on the blind spot.

15. The method of claim 14, comprising:
detecting an object in the images, and
depicting a schematic representation of said object in said area.

16. The method of claim 14, comprising:
associating a windshield area used for mounting rearview mirrors in non-commercial vehicles with a blind spot behind the commercial vehicle; and
determining that the blind spot behind the commercial vehicle is part of the current field of view of the driver based on the current field of view including said windshield area.

17. The method of claim 12, wherein the camera is one of a plurality of cameras configured to record images of respective blind spots of the commercial vehicle, the method comprising:
selecting one of the plurality of cameras based on the viewing direction; and
obtaining or deriving the graphical elements from images provided by the selected camera.

18. The method of claim 12, comprising:
obtaining data indicative of how the driver is operating the commercial vehicle; and
displaying additional graphical elements on the electronic display based on the obtained data.

19. The method of claim 18, wherein said obtaining data indicative of how the driver is operating the commercial vehicle comprises obtaining data indicative of one or both of a shift position of a gear selection device and a steering angle of the commercial vehicle.

20. The method of claim 12, comprising:
recording images of an interior of a cabin of the commercial vehicle; and
detecting the blind spot based on the images of the interior of the cabin.
